(19) United States
(12) Patent Application Publication
(10) Pub. No.: US 2010/0028652 A1
(43) Pub. Date: Feb. 4, 2010

(54) METAL STRUCTURE WITH ANTI-EROSION WEAR-PROOF AND MANUFACTURED METHOD THEREOF

(75) Inventors: CHIA-HUA CHANG, TAOYUAN (TW); JEN-CHIN WU, TAOYUAN (TW); CHIN-LUNG CHANG, TAOYUAN (TW); PI-CHUN HO, TAOYUAN (TW)

Correspondence Address: ROSENBERG, KLEIN & LEE, 3458 ELLICOTT CENTER DRIVE-SUITE 101, ELLICOTT CITY, MD, 21043, US

(73) Assignee: CHUNG SHAN INSTITUTE OF SCIENCE AND TECHNOLOGY, ARMAMENTS BUREAU, M.N.D., TAOYUAN COUNTY (TW)

(21) Appl. No.: 12/181,646

(22) Filed: Jul. 29, 2008

(51) Int. Cl. B32B 15/18; B44C 1/22; C23F 1/00; B05D 3/10; B05D 3/12

(52) U.S. Cl. 428/319.1; 216/52; 216/100; 427/309

(57) ABSTRACT

The present invention relates to a metal structure with anti-erosion wear-proof and manufactured method thereof. The metal structure with anti-erosion wear-proof includes a metal substrate; a protective layer formed on the metal substrate, the protective layer has a plurality of openings; and an oxide layer formed on the protective layer. The manufactured method of metal structure with anti-erosion wear-proof includes the steps of providing a metal substrate; forming a protective layer on the metal substrate, the protective layer has a plurality of openings; and forming an oxide layer on the protective layer. The present invention transforms the surface of the protective layer into the oxide layer to increase the anti-erosion and wear-proof character of the metal substrate.

### BACKGROUND OF THE INVENTION

1. Field of the Invention

The present invention relates to a metal structure and manufactured method thereof, and more particularly, to a metal structure with anti-erosion wear-proof and manufactured method thereof, which can increase the anti-erosion and wear-proof of a metal substrate by forming a fine-dense oxide layer on a protective layer attached to the metal substrate through an electrochemistry reaction.

2. Description of the Prior Art

Metal is common material in industry. For example, the steel is easy to rust in the atmosphere. Especially, the climate is very moist in Taiwan of the subtropical zone so the question of rusty steel cause ten millions of the machine parts, facilities and equipments discarded. Hence, the antirust technology is a very serious topic for study. In the prior art, the antirust technologies has an organic spreading method (spreading a zinc powder lacquer or an epoxy paint on the steel, etc), an electroplating method (electroplating chromium, nickel or zinc on the steel), an heat dipped plating method (plating zinc, aluminum, tin or zinc aluminum alloy) and an metal melting injection method (forming a melting injection layer on the steel).

The metal melting injection method can protect the steel for a long time. The common metal melting injection materials has zinc, aluminum and zinc aluminum alloy, etc. Nevertheless, the melting injection layer is a cover film of many openings. The cover film must be sealed for filling the openings, so as to reduce the opportunity of the outer rusty factor into the steel substrate and further increase anti-erosion of the steel. The common sealed agent is a fluid silicon material.

When the steel with the melting injection layer is applied to many parts of the precise mechanism, the sealed agent can't be spread on the melting injection layer that is due to precise requirement. The combined parts, rotary elements or sliding elements of the prior mechanisms usually adopt electroplate hard chromium to increase the anti-erosion and wear-proof character of the steel. In industry, the six valence chromium are common used but the six valence chromium has a quite toxicity for human and its excited character and erosion character will hurt the skin and the upper respiratory to cause cancer reaction. Besides, plating chromium produces the waste water and environment question, etc that will be detested by people. The environmental consciousness is raised at recently years so many countries limit or forbid to use the six valence chromium. For example, the European Union ruled that the electric machinery and electronic equipments can't include the six valence chromium since 2006 and the six valence chromium is forbidden to use since 2007. The other countries like American and Japan, etc, which will follow the European Union continually.

The replaced plans of the plating chromium have the plating nickel wolfram alloy, high speed burned oxygen melting injection carbonization wolfram, nickel alloy material, nickel-aluminum-phosphorous or nickel-cobalt-phosphorous of three units chemical nickel and discharging covered nickel-chromium hard alloy, etc. Though, the anti-erosion characters of the above replaced plans are not as good as plating hard chromium. The plating layer is more fine and dense by chemical nickel method or electroplating method but the thickness of film is limited. The many openings plating layer is got by melting injection method or discharging covered method so the many openings plating layer can't used in the moist environment.

The spraying and spreading material of the melting injection method has high chemical activities and are soft light metal so can't be applied to anti-erosion wear-proof occasions. The melting injection layer common uses after-treatment technology, which like organic sealed opening method, is not applied to combined parts, rotary elements or rotary elements of the mechanisms. Hence, the melting injection method is very limited to use.

Hence, the inventor provide a metal structure with anti-erosion wear-proof and manufactured method thereof, which can improve defect of soft and having many openings of the melting injection layer on the metal substrate (like steel substrate) to increase the wear-proof character of the metal substrate with melting injection aluminum layer or aluminum alloy layer. The metal structure with anti-erosion wear-proof and manufactured method thereof of the present invention can be applied to combined parts, rotary elements or rotary elements of the mechanisms or other high wear-proof occasions and the metal structure with anti-erosion wear-proof can be used in moist environment and not occur rusty phenomenon.

### SUMMARY OF THE INVENTION

The primary objective of the present invention provides for a metal structure with anti-erosion wear-proof and manufactured method thereof. A fine and dense oxide layer is formed on the protective layer of a plurality of openings to seal the openings of the protective layer and increase the anti-erosion character of the metal substrate in the moist environment.

The secondary objective of the present invention provides for a metal structure with anti-erosion wear-proof and manufactured method thereof. A fine and dense oxide layer is formed on the protective layer of a plurality of openings to increase the wear-proof character of the metal substrate. The metal structure with anti-erosion wear-proof can be applied to combined parts, slid elements or rotary elements of the mechanisms or other high wear-proof occasions.

The present invention relates to a metal structure with anti-erosion wear-proof and manufactured method thereof. The metal structure with anti-erosion wear-proof comprises a metal substrate; a protective layer formed on the metal substrate, the protective layer has a plurality of openings; and an oxide layer formed on the protective layer. The manufactured method of metal structure with anti-erosion wear-proof comprises the steps of providing a metal substrate; forming a protective layer on the metal substrate, the protective layer has a plurality of openings; and forming an oxide layer on the protective layer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the preferred embodiment of the metal structure with anti-erosion wear-proof in the present invention.

FIG. 2 is a step flow chart of the preferred embodiment of the manufactured method of the metal structure with anti-erosion wear-proof of the present invention.

### DETAILED DESCRIPTION OF THE PREFERRED EMBODIMENT

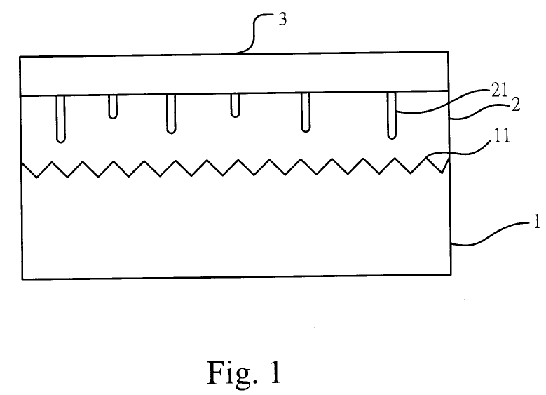

Please see the FIG. 1, which is a schematic diagram of the preferred embodiment of the metal structure with anti-erosion wear-proof in the present invention. The metal structure with anti-erosion wear-proof comprises a metal substrate 1. The material of the metal substrate is selected from the group consisting of copper, zinc, lead, iron and common used metal. In this embodiment, the metal substrate is steel. The metal substrate has a rough surface 11 and the rough surface 11 can increase the material adhesion on the metal substrate 1. A protective layer 2 is formed on the metal substrate and the protective layer 2 is formed by melting injection method in non-oxygen environment. The protective layer 2 is aluminum and aluminum alloy layer. The aluminum alloy is selected from the group consisting of aluminum magnesium alloy, aluminum manganese alloy, aluminum copper alloy, aluminum zinc alloy, aluminum silicon alloy, aluminum titanium alloy and aluminum magnesium silicon alloy. The thickness of the protective layer 2 is 50˜500 μm and the protective layer 2 has a plurality of openings 21. The oxide layer 3 is formed on the protective layer 2 and the oxide layer 3 is a fine and dense alumina layer or aluminum alloy oxide layer. The aluminum alloy oxide is selected from the group consisting of aluminum magnesium alloy oxide, aluminum manganese alloy oxide, aluminum copper alloy oxide, aluminum zinc alloy oxide, aluminum silicon alloy oxide, aluminum titanium alloy oxide and aluminum magnesium silicon alloy oxide. The oxide layer 3 is a separated and wear-proof layer for the protective layer 2 to avoid the outer water, oxide or other etching factor into the openings 21 of the protective layer 2 that can avoid the metal substrate 1 rusty. Also, the oxide layer 3 can increase the hardness of the protective layer 2 to improve the anti-erosion and wear-proof character of the metal substrate.

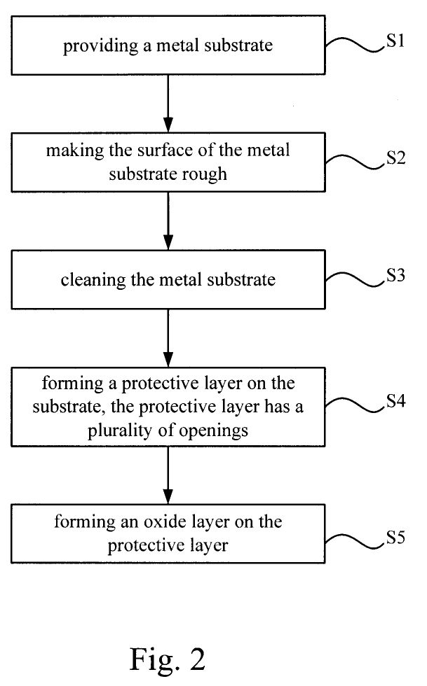

Please see the FIG. 2, which is a step flow chart of the preferred embodiment of the manufactured method of the metal structure with anti-erosion wear-proof of the present invention. The step flow chart of the preferred embodiment of the manufactured method of the metal structure with anti-erosion wear-proof of the present invention comprises the following steps.

The step S1 is a step of providing a metal substrate. The material of the metal substrate is selected from the group consisting of copper, zinc, lead, iron and common used metal. In this embodiment, the metal substrate is steel.

The step S2 is a step of making the surface of the metal substrate rough. The protective layer has a plurality of openings. A step of spurting sand, mechanical rough rub or chemical etching is used to attain to the step S2.

The step S3 is a step of cleaning the metal substrate. The high pressure fluid, the supersonic oscillator or the metal clean agent is used to attain to the object of the cleaning the metal substrate.

The step S4 is a step of forming a protective layer on the substrate, the protective layer has a plurality of openings. The protective layer has a plurality of openings and the protective layer is formed by melting injection method in non-oxygen environment. The temperature of the melting injection method is 100˜250°. In the first step of the melting injection method, aluminum or aluminum alloy is led into the high frames, the electric arc or the plasma to form melting status and semi-melting status by heating. Then, the high pressure gas makes the aluminum drop or aluminum alloy drop of the melting status and the semi-melting status rapidly sprayed and deliver the sprayed aluminum drop or aluminum alloy drop on the metal substrate. After cooling and solidify, the aluminum or aluminum alloy protective layer is formed on the metal substrate. The process of forming the melting injection layer is a rapidly cooling process so the protective layer has a plurality of openings. Different melting injection processes (The melting injection method of the present invention can be a heat melting injection method or plasma melting injection method.), heat source, injection speed or cooling time will determine the quality and structure of the protective layer.

The step S5 is a step of forming an oxide layer on the protective layer. The anode treatment proceeds on the protective layer to transform the aluminum or aluminum alloy of the protective layer into alumina and aluminum alloy oxide through the electrochemistry reaction. Hence, the fine and dense oxide layer is formed and the fine and dense oxide layer is a sealing openings layer for the protective layer to avoid the outer etching factors into the openings of the protective, which will make the metal substrate rusty. Also, the oxide layer can increase the hardness of the protective layer and increase the anti-erosion wear-proof character of the metal substrate. In the anode treatment method of the present invention, aluminum or aluminum alloy is treated as an anode and aluminum, lead, carbon stick or platinum is treated as a cathode and then a direct current, an alternating current or a pulse current is provided to make the surface of the aluminum or the aluminum alloy to form alumina or the aluminum alloy oxide. The anode treatment method proceeds in the acid electrolyte. The anode treatment method is a chromic acid anode method, a sulfuric acid anode method, a phosphoric acid anode method, a boric acid anode method, an oxalic acid anode method or an organic acid anode method according to the electrolytic classification. Besides, the anode treatment method can also proceeds in neutral electrolyte or base electrolyte. The more fine and dense oxide layer (barrier wall type oxide film) is got by anode treatment in the neutral electrolyte. The more openings oxide layer (more openings oxide film) is got by anode treatment in the acid electrolyte or weak base electrolyte. The more openings oxide film has larger hardness, anti-erosion character, wear-proof character and chemical stability. For example, aluminum is treated by anode treatment, whose chemical reaction is as following.

Al→Al³⁺+3e⁻

Al³⁺+3OH⁻→Al(OH)₃

2 Al(OH)₃→Al₂O₃□H₂O+2H⁺+2OH⁻

Al₂O₃+6H⁺→2Al³⁺+3H₂O

The openings of the oxide layer can be further sealed because the anode treatment of aluminum or aluminum alloy still produces some micro-openings. Those micro-openings will tend to absorb the chemical substances in the environment so that the aluminum or aluminum alloy structure will be destroyed. The step of sealing openings of the oxide layer is a step of heat water sealing openings, chromate sealing openings, nickel acetate sealing openings or cesium salt sealing openings. Besides, smaller openings and the fine and dense oxide layer is got by adding ammonium molybdate into the electrolyte.

According above mention, the metal structure with anti-erosion wear-proof and manufactured method thereof can increase the anti-erosion character of the metal substrate (like steel substrate). The present invention can be applied to combined parts, slid elements or rotary elements of the mechanisms or other high wear-proof occasions.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A metal structure with anti-erosion wear-proof comprising:
a metal substrate;
a protective layer formed on the metal substrate, the protective layer has a plurality of openings; and
an oxide layer formed on the protective layer.

2. The metal structure with anti-erosion wear-proof according to claim 1, wherein the metal substrate is a steel substrate.

3. The metal structure with anti-erosion wear-proof according to claim 1, wherein the metal substrate has a rough surface.

4. The metal structure with anti-erosion wear-proof according to claim 1, wherein the protective layer is selected from the group consisting of aluminum and aluminum alloy.

5. The metal structure with anti-erosion wear-proof according to claim 4, wherein the aluminum alloy is selected from the group consisting of aluminum magnesium alloy, aluminum manganese alloy, aluminum copper alloy, aluminum zinc alloy, aluminum silicon alloy, aluminum titanium alloy and aluminum magnesium silicon alloy.

6. The metal structure with anti-erosion wear-proof according to claim 1, wherein a thickness of the protective layer is 50-500 μm.

7. The metal structure with anti-erosion wear-proof according to claim 1, wherein the oxide layer is selected from the group consisting of alumina and aluminum alloy oxide.

8. The metal structure with anti-erosion wear-proof according to claim 7, wherein the aluminum alloy oxide is selected from the group consisting of aluminum magnesium alloy oxide, aluminum manganese alloy oxide, aluminum copper alloy oxide, aluminum zinc alloy oxide, aluminum silicon alloy oxide, aluminum titanium alloy oxide and aluminum magnesium silicon alloy oxide.

9. A manufactured method of metal structure with anti-erosion wear-proof comprising the steps of:
providing a metal substrate;
forming a protective layer on the metal substrate, the protective layer has a plurality of openings; and
forming an oxide layer on the protective layer.

10. The manufactured method of metal structure with anti-erosion wear-proof according to claim 9 further comprising a step of making a surface of the metal substrate roughness.

11. The manufactured method of metal structure with anti-erosion wear-proof according to claim 10, wherein the step of making the surface of the metal substrate roughness is a step of spurting sand, mechanical rough rub or chemical etching.

12. The manufactured method of metal structure with anti-erosion wear-proof according to claim 10, further comprising a step of cleaning the metal substrate after the step of making the surface of the metal substrate roughness.

13. The manufactured method of metal structure with anti-erosion wear-proof according to claim 9, wherein the step of forming an oxide layer on the protective layer further comprises a step of sealing openings of the oxide layer.

14. The manufactured method of metal structure with anti-erosion wear-proof according to claim 13, wherein the step of sealing openings of the oxide layer is a step of heat water sealing openings, chromate sealing openings, nickel acetate sealing openings or cesium salt sealing openings.

15. The manufactured method of metal structure with anti-erosion wear-proof according to claim 9, wherein a melting injection method is used to form the protective layer.

16. The manufactured method of metal structure with anti-erosion wear-proof according to claim 15, wherein a temperature of the melting injection method is between 100° and 250°.

17. The manufactured method of metal structure with anti-erosion wear-proof according to claim 9, wherein an anode treatment method is used to form the oxide layer.

18. The manufactured method of metal structure with anti-erosion wear-proof according to claim 17, the anode treatment method is a chromic acid anode method, a sulfuric acid anode method, a phosphoric acid anode method, a boric acid anode method, an oxalic acid anode method or an organic acid anode method.
